(19) United States
(12) Patent Application Publication
(10) Pub. No.: US 2023/0272894 A1
(43) Pub. Date: Aug. 31, 2023

(54) OPTICALLY EMBEDDED FLEXIBLE FILAMENT

(71) Applicant: LUMILEDS LLC, San Jose, CA (US)

(72) Inventors: Floris Maria Hermansz Crompvoets, Bunde (NL); Christian Kleijnen, Ell (NL); Florent Monestier, Kerkrade (NL)

(73) Assignee: LUMILEDS LLC, San Jose, CA (US)

(21) Appl. No.: 18/007,715

(22) PCT Filed: Jun. 3, 2021
(86) PCT No.: PCT/US2021/035792

§ 371 Date: Dec. 1, 2022

Related U.S. Application Data
(60) Provisional application No. 63/034,181, filed on Jun. 3, 2020.

(30) Foreign Application Priority Data
Jul. 28, 2020 (EP) 20188191.9

(51) Int. Cl. F21S 41/24; F21S 4/22; G02B 27/30

(52) U.S. Cl. CPC F21S 41/24; F21S 4/22; G02B 27/30; F21S 41/141

(57) ABSTRACT

Lighting devices, methods of manufacturing a lighting device, automotive lighting systems including the lighting device are described. A lighting device includes at least one light guide. The at least one light guide includes a cavity having a middle. The at least one light guide is a parabolic collimator having its focus point coincide with the middle of the cavity. The lighting device also includes an encapsulating material that has at least one opening through which light is emitted. The lighting device also includes at least one light-emitting element embedded into the cavity of the light guide. The light-emitting element has a coating oriented towards the at least one opening of the encapsulating material.

### CROSS REFERENCE TO RELATED APPLICATIONS

This application claims the benefit of U.S. Provisional Patent Application No. 62/034,181, which was filed on Jun. 3, 2020, and European Patent Appln. No. 20188191.9, which was filed on Jul. 28, 2020, the contents of which are hereby incorporated by reference herein.

### BACKGROUND

Light-emitting elements, such as LEDs, may be arranged on a substrate that is also used for electrical connection of the light-emitting elements. For example, light-emitting elements may be arranged on a printed circuit board (PCB) that comprises conductive tracks to provide the light-emitting element with electrical energy. However, substrates such as a PCBs may restrict the shape of a lighting device, such as to an essentially flat shape in case of a simple board.

### SUMMARY

Lighting devices, methods of manufacturing a lighting device, automotive lighting systems including the lighting device are described. A lighting device includes at least one light guide. The at least one light guide includes a cavity having a middle. The at least one light guide is a parabolic collimator having its focus point coincide with the middle of the cavity. The lighting device also includes an encapsulating material that has at least one opening through which light is emitted. The lighting device also includes at least one light-emitting element embedded into the cavity of the light guide. The light-emitting element has a coating oriented towards the at least one opening of the encapsulating material.

### BRIEF DESCRIPTION OF THE DRAWINGS

A more detailed understanding can be had from the following description, given by way of example in conjunction with the accompanying drawings wherein:

FIG. 1a is a schematic representation of an example lighting device in a perspective view;

FIG. 1b is a schematic representation of the lighting device of FIG. 1a in a cross-sectional view;

FIGS. 2a and 2b are perspective views of a lighting module of the lighting device of FIGS. 1a and 1b;

FIG. 3 is a schematic representation of another example lighting device in a cross-sectional view;

FIG. 4a is a schematic representation of the lighting device of FIG. 3 in a cross-sectional view with visualized rays from optical simulation;

FIG. 4b is a diagram of the resulting intensity profile of the optical simulation performed according to the lighting device of FIG. 4a;

FIG. 5a is a schematic representation of another example lighting device in a cross-sectional view with visualized rays from optical simulation;

FIG. 5b is a diagram of the resulting intensity profile of the optical simulation performed according to the lighting device of FIG. 5a;

FIG. 6 is a flow diagram of an example method of manufacturing a lighting device;

FIG. 7 is a diagram of an example vehicle headlamp system that may incorporate one or more of the embodiments and examples described herein; and

FIG. 8 is a diagram of another example vehicle headlamp system.

### DETAILED DESCRIPTION

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

In automotive lighting, it may be desirable to style the luminous appearance of a lamp. For example, signaling functions, such as turn-light, position-light, stop-light, and daytime-running-light (DRL) may be suited to be tailored to, for example, the designer's wishes. These signaling applications may be designed as line emitters in car lamps.

A product that may provide a high freedom of styling for line sources is 3D LED technology, which is a bi-axial bendable line emitter. Line sources may enable high flexibility, fluxes, uniformity and compactness due to integration of a dedicated LED on wire solution using mid power LED packages (also referred to as front-end), which may be assembled into an elongated optical system (also referred to as back-end).

This front-end technology combined with an additional optical system, also known as the back-end, basically is a silicone based elongated mix box with a dedicated diffusor to create a homogeneous light emitting area. The assembly of the front-end and the back-end may form an elongated LED module that can be implemented in a car lamp, in a car body, or even in car interior. Combination of this source with additional optics can even create a surface light.

Current LED architectures enabling such a 3D-shape may meet some automotive signaling application specifications. However, higher intensity or directionally are often needed than such architectures can provide. Further, the current 3D LED architecture may be particularly suited for single direction emission (or one-sided emission), making it good as a source for blades and light guides or simply as direct emitter. However, sometimes a bi-directional or even omni-directional emission may be preferred (e.g., as part of a surface emitter), and this may not be realizable with the current design. Such 3D LED architectures may also not allow for easy optical integration.

Embodiments described herein may provide for a lighting device, such as for automotive applications, and corresponding methods of manufacture, that may provide for a desired 3D-shape while enabling enhanced effective light etendue.

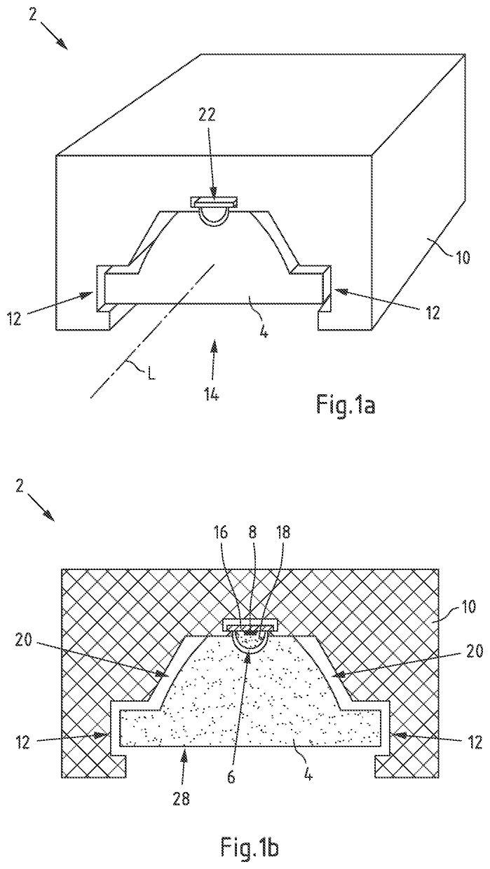

FIG. 1a is a schematic representation of an example lighting device 2 in a perspective view. The lighting device 2 may be, for example, an optical system. In the example illustrated in FIG. 1a, the lighting device 2 includes encapsulating material 10 and a light guide 4 arranged within the encapsulating material 10. In some embodiments, the light guide 4 at may be a parabolic collimator, which may have a flat surface 28 (see FIG. 1b) arranged in line with an opening 14 in the encapsulating material 10 In some embodiments, the flat surface may be opposite to the parabolic cross-section of the collimator such that light that is emitted by at least one light-emitting element may be guided by the at least one light guide in a direction of the flat surface. The flat surface may be oriented towards the opening of the encapsulating material so that light is directed in this direction.

The recess may comprise one or more mechanical reference features to enable the light emitting element to be embedded in the light guide in a way defined by the mechanical reference features (e.g., orient the light emitting elements relative to the light guide). For example, to enable a fixation of the light guide 4 within the opening 14 in the encapsulating material 10, the light guide 4 may include a mechanical reference element 12 at the right and left sides of the light guide 4. Correspondingly, the encapsulating material 10 may have respective recesses, such as slots, in which the mechanical reference elements 12 of the light guide 4 can be inserted. Further, the light guide 4 may have a recess 6 (see FIG. 1b) in which a lighting module 22 may be embedded, at least in part. Further, the lighting module 22 may be inserted with its other part in a recess shown at the top side of the encapsulating material 10. In some embodiments, a fixation feature may be provided by one or more mechanical reference features of the encapsulating material.

The encapsulating material may comprise or have one or more mechanical reference features to enable that the light guide can be arranged in relation to the encapsulating material in a way defined by the mechanical reference features (e.g., orient the light guide with regard to a certain rotation and/or position of the light guide relative to the encapsulating material). Such one or more mechanical reference features of the encapsulating material may, for instance, be a slot, gap, or cavity, for example. Such one or more mechanical reference features of the encapsulating material may, for instance, have a certain shape. Correspondingly, the light guide may have corresponding mechanical reference features, which may, for example, enable a form-fit of the mechanical reference features of the light guide and the mechanical reference features of the encapsulating material.

In embodiments, the parabolic collimator may be parabolically shaped. It will be understood that this may mean, as used herein, that the collimator is parabolically shaped in its cross-section, at least in its main. This does not exclude that the collimator may comprise one or more feature, for example, for mechanical connection to one or more further elements (e.g., to the encapsulating material) that do not match the parabolic shape.

According to some embodiments, the collimator may include a flexible material. The collimator may be made of a flexible material, such as an optical grade silicone. In this way, applications, such as automotive lighting, such as tail-lighting, stop-lighting, indicator-lighting, or DRL, can be very freely designed in their respective form and shape.

A light guide, such as the light guide 4, can carry optical light over a distance via a particular route to a defined light-emitting surface (e.g., with minimal loss). The radiation characteristic of the light emitted from the light guide can hence be precisely controlled to, for example, fulfil the legal requirements. To this end, a suitable transmittance and/or reflectivity of the surfaces of the light guide can be adjusted. The light guide may be manufactured from any suitable optically transparent material.

FIG. 1b is a schematic representation of the lighting device 2 of FIG. 1a in a cross-sectional view. In the example illustrated in FIG. 1b, the lighting device 2 includes a lighting module 22, which includes a flexfoil 16 on which multiple light-emitting elements 8 are arranged. The flexfoil 16 may be covered with a phosphor coating 18 (not marked in FIGS. 1a and 1b) to convert a wavelength of light emitted by the light-emitting elements 8.

A flexfoil may refer to a flexible strip that may comprise a number of conductor tracks provided by the flexible strip. With the conductor tracks, one or more light-emitting elements can be connected with each other. Further, by connecting a power source as well, the one or more light-emitting elements can be driven to emit light. The flexfoil may be very thin and can be bended in at least three different directions. The flexfoil may represent a carrier on which at least one light-emitting element can be arranged. The flexfoil may be of elongated shape so that a plurality (e.g., at least two) of light-emitting elements can be arranged on the flexfoil.

Thus, the flexfoil may be a carrier for the light-emitting elements. In this way, light emitted by the light-emitting elements may be guided by the light guide in one or more direction. For instance, the light guide may guide the light emitted by the light-emitting elements in such a way that the light is evenly distributed in a certain direction.

When the light guide 4 is inserted in the encapsulating material 10, an air gap 20 may be present between the light guide 4 and the encapsulating material 10. Further, another air gap (not shown in FIGS. 1a and 1b) may be present between the lighting module 22 and the light guide 4. This latter air gap may be established between the coating 18 covering the flexfoil 16 and the light guide 4.

The lighting module 22 may represent a lighting module (e.g., a filament 3D LED light source also referred to as front-end architecture) of the lighting device 2. The encapsulating material 10 may, for example, be a white mix box also representing a back-end architecture of the lighting device 2. The lighting module 22 (e.g., the filament) may be inserted or integrated in this mix box as a front-end architecture, as shown in FIGS. 1a and 1b. In this way, the light guide 4 may be optically coupled to the light-emitting elements 8 of the lighting module 22.

The encapsulating material 10 may further enable protection of the light guide 4 and the lighting module 22. In addition, the encapsulating material 10 may avoid stray light emitted in a direction of the encapsulating material 10, and not to its opening 14, since this light can either be blocked by the encapsulating material 10 or it can be reflected back into the direction of the opening 14. In this way, the lighting device 2 may enhance optical efficiency.

Since emitted light may also escape in a direction of the bottom of the encapsulating material, it may be desirable that the encapsulating material have high reflective properties. Thus, light passing through the light guide in a direction that is encapsulated by the encapsulated material can be reflected back to the light guide. The light guide can then guide the light in a direction of the opening. The intensity of light emitted by the lighting device may be strongly peaked due to the lighting device 2. Stray light or light that is not guided by the light guide in a direction of the opening can be dealt with by a reflection of this light by the encapsulating material.

For instance, the encapsulating material may have a reflectivity, at least in part, above 95% in reflectance to achieve a well-suited encapsulating material efficiency. High reflective silicone materials may be used that are typically filled with a metal oxide, for example TiO2. The load of these materials can be in a range from 5 to 30 wt. %. A too high amount of particle load may make the silicone less flexible and even brittle. To enhance reflectivity, the encapsulating material may represent a white mix box. The material out of which the encapsulating material is made may, thus, represent a white color having the above-mentioned reflectance. Effective etendue may be increased due to a compromise between efficiency and beam width that may be enabled by example embodiments described herein. The encapsulating material can reflect light in all directions. The light guide may collimate the light as well as possible since stray light not collimated (e.g., not directly collimated) into the desired direction may be captured by the encapsulating material and reflected back through the light guide and through the opening. This light may be emitted in a broader fashion than the light that directly emerges through the opening.

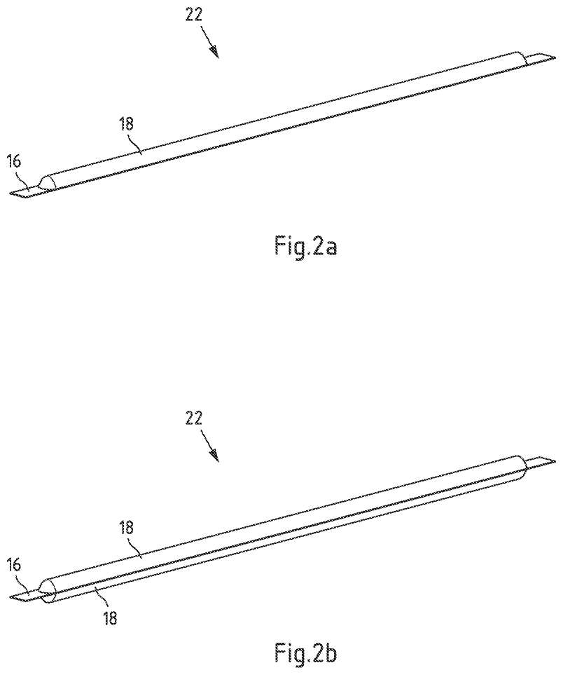

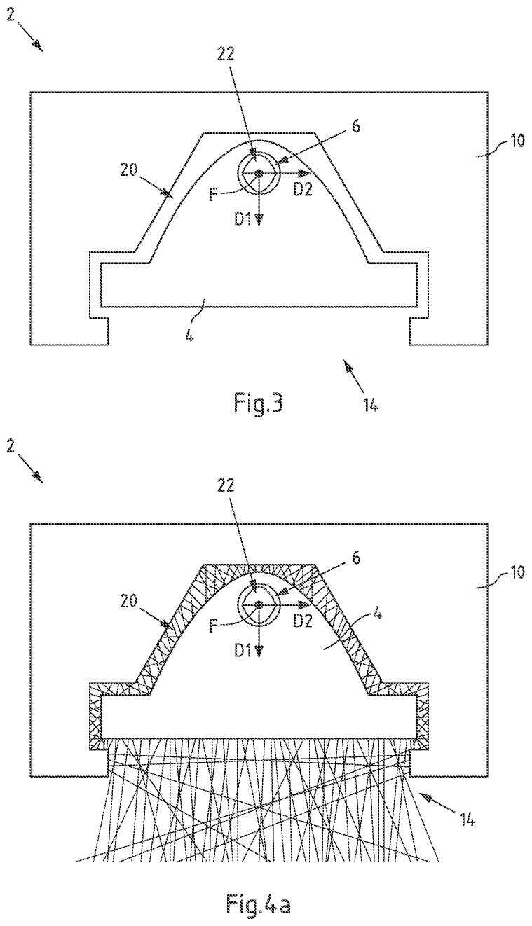

The light guide 4 may be considered to represent a classical Total Internal Reflection (TIR) collimator in combination with the lighting module 22 (described in more detail below with respect to FIGS. 2a and 2b). Such a collimator may be an optical element that is designed to collimate light emitted by the light-emitting elements in at least one main direction. This may not exclude that some light emitted by the light-emitting elements may be emitted in a direction that differs from such a main direction. The collimator may have one or more optically smooth surfaces to facilitate optimal TIR conditions where needed. The respective lighting module 22 may radiate in a hemispherical fashion (instead of an omni-directional fashion as shown in the embodiments of FIGS. 3, 4a and 5a).

According to some embodiments, multiple light-emitting elements may be arranged along a longitudinal direction of the lighting device. The lighting device may have a longitudinal direction that may correspond to the longest dimension of the lighting device. The light-emitting elements may be at least partially arranged along the longitudinal direction relative to each other. The light-emitting elements may, for example, be arranged in intervals along the longitudinal direction in regular or irregular intervals. For instance, the lighting device may substantially comprise the shape of a strip, for example with a substantially constant cross section. With this arrangement of the light-emitting elements, the lighting device may be configured basically as a semi-finished product in an endless or one-dimensional manner, significantly reducing production costs and allowing choosing the length of the lighting device after production of the semi-finished product.

In some embodiments, the flexfoil may be coated, at least in part, with a coating. The coating may define at least one wavelength in which light emitted by the light-emitting elements is converted. In some embodiments, the coating may be a phosphor coating, although alternatives to phosphor will be understood by one of ordinary skill in the art. The phosphor coating may act as a wavelength converter, enabling, for example, to change the frequency of the light that is visible. It will be understood that in, addition or in alternative to the phosphor coating, a respective coating that blocks light in a certain direction and/or that defines a certain wavelength and/or intensity in which the emitted light is converted, can be used.

For color or light distribution of the emitting light, a phosphor in silicone or metal oxide (e.g., TiO2) in silicone can be applied as a coating for optical functionality onto the light-emitting elements arranged on the flexfoil. The coating (e.g., phosphor in silicone or metal oxide in silicone) may be arranged on one or both sides of the flexfoil. This can be done on one side providing a source with hemispherical emissions. If a transparent or translucent flexfoil is used and phosphor in silicone or metal oxide in silicone is applied on both sides, an omni-directional emitting flexfoil filament may be achieved. Thus, if the flexfoil has at least one light-emitting element arranged on both of its sides, the emission of light may be omnidirectional. The flexfoil may either be transparent or opaque. Such an omnidirectional emission of light may also be enabled if the flexfoil is transparent and has at least one light-emitting element on one side, not on both sides. Then, even if at least one light-emitting element is arranged on one side of the flexfoil, the emission of light may be omnidirectional since it can penetrate through the transparent flexfoil. The flexfoil and the at least one light-emitting element providing omnidirectional emission of light may also be referred to as a flexfoil filament. Such a type of flexfoil filament typically finds its application in retrofit light bulbs.

In the alternative, the flexfoil and at least one light-emitting element providing hemispherical emission may also be referred to as a flexfoil with hemispherical emission. Such a flexfoil with hemispherical emission may emit light to one side of the flexfoil. Such a flexfoil with hemispherical emission may, thus, have a blocking layer on the opposite side or may be opaque (e.g., a solid layer) or not transparent so that the emission of light may be directed to one side of the flexfoil. The blocking layer or solid layer may ideally be reflective for efficiency reasons. In this way, as little light as possible may be lost, and at least a part of the reflected light can be emitted in the intended direction. According to some embodiments, the flexfoil and the coating may form a hemispherical shape, wherein the flexfoil together with the coating may be embedded, at least in part, into the encapsulating material, and further, at least in part, into the at least one light guide. This may enable a hemispherical emission of light when, for example, multiple of light-emitting elements are arranged on the flexfoil and correspondingly powered to emit light. A power source may be connected via conductive tracks provided on the flexfoil. The hemispherical shape may enable that light may not be emitted in a direction of the bottom side opposite to a top side on which the light-emitting elements are arranged. Furthermore, to enhance the blocking of light into the direction of the bottom side of the flexfoil, optionally a further coating blocking light to be emitted on the bottom side may be applied onto the bottom side of flexfoil.

According to some embodiments, the encapsulating material may surround the at least one light guide at three sides so that light emitted by the at least one light emitting element is blocked or reflected by the encapsulating material. Thus, in a state in which the light guide is mounted to the encapsulating material, the encapsulating material may enclose three sides of the light guide from a cross-sectional perspective of the light guide. In this way, light may be emitted by the light-emitting elements in the direction that is not surrounded or covered by the encapsulating material.

FIGS. 2a and 2b are perspective views of the lighting module 22 of the lighting device 2 of FIGS. 1a and 1b. In the example illustrated in FIG. 2a, the lighting module 22 includes a flexfoil 16 coated with a phosphor coating 18. The flexfoil 16 may be a flexfoil strip. Multiple light-emitting elements may be arranged on the flexfoil 16. The multiple light-emitting elements may be connected together by conductive tracks provided by the flexfoil 16. The phosphor coating 18 may be applied (e.g., molded or dispensed) on the top side, as shown in FIG. 2a of the flexfoil 16. This may enable a hemispherical emission of light when the multiple light-emitting elements are powered. A power source (not shown in FIGS. 2a and 2b) may be coupled via the conductive tracks to the light-emitting elements. Light may not be emitted on the bottom side of the flexfoil 16. To enhance the blocking of light into the direction of the bottom side of the flexfoil 16, optionally, a further light-blocking coating that blocks light to be emitted on the bottom side may be applied onto the bottom side of the flexfoil 16.

The lighting module 22 including the flexfoil 16 and the coating 18 may form a hemispherical shape, wherein the flexfoil 16 together with the coating 18 may be intended to be embedded, at least in part, into the encapsulating material 10, and further, at least in part, into the at least one light guide 4. This is shown, for example, by the example embodiment of the lighting device 2 of FIG. 1a and FIG. 1b.

In the example illustrated in FIG. 2b, the lighting module 22 includes a flexfoil 16 coated with a phosphor coating 18 on both of its sides (e.g., the top and bottom sides) is shown. This is indicated in FIG. 2b by the phosphor coating 18 marked by two corresponding reference signs. Multiple light-emitting elements may be arranged on the flexfoil 16. The multiple light-emitting elements may be connected by conductive tracks. Covering the flexfoil 16 on both sides with, for example, a phosphor coating 18, may enable an omni-directional emission of light when the multiple of light-emitting elements are driven. Thus, the flexfoil 16 of FIG. 2b may emit light to all sides evenly when it is powered. It will be understood that coatings other than a phosphor coating are possible, such as to adapt the lighting module 22 to certain optical requirements and/or applications, for example.

FIG. 3 is a schematic representation of another example lighting device 2 in a cross-sectional view. In the example illustrated in FIG. 3, the lighting device 2 includes a light guide 4 with a recess 6. In the illustrated example, the recess 6 is a cavity, and the light guide 4 represents an optical element with the cavity being an extruded hole. The cavity can be used to insert a lighting module 22, as described above, such as an LED filament, as shown in FIGS. 2a and 2b can be inserted into the cavity.

The light guide may have an elongated shape, and the recess may be elongated and extend along the entire length of the light guide (e.g., in a longitudinal direction of the light guide). The collimator may surround, at least in part, the light emitting elements. In some embodiments, the collimator may fully surround the light emitting elements.

The collimator may have its focus respectively focus point in the recess. As shown in the illustrated example, the focus point F of the parabolic collimator representing the light guide 4 is in the middle of the cavity 6. A lighting module 22 may be oriented in the cavity in such a way that the side that comprises the coating 18 (see FIG. 2a) is oriented to the opening 14 of the encapsulating material 10. This is indicated in FIG. 3 by the two directions D1 and D2. D1 and D2 mark two arrows that indicate possible directions in which light may be emitted by such a hemispherical lighting module 22 embedded into the recess or cavity 6. Thus, from a perspective of a viewer of FIG. 3, light may be emitted to the bottom, left and right hand side of the flexfoil 16. Further, it can be seen that an air gap 20 may be established both between the light guide 4 and the encapsulating material 10 and between the lighting module 22 and the inner walls of the recess 6 in the form of a cavity (not shown).

According to some embodiments, the air gap 20 may be established between the light-emitting elements and the light guide when the light-emitting elements are embedded into the recess of the light guide. If the light-emitting elements are arranged on another element, such as a flexfoil, the air gap may be between at least a part of the element (e.g., flexfoil) on which the light-emitting elements are arranged and the recess of the light guide. Thus, at least a part or section of the recess in the light guide may not be in direct contact with the light-emitting elements or another element on which the light-emitting elements are arranged. Such an air gap may enable a good optical collimation effect. For instance, such an air gap may act as an interface. In practice, such an air gap may always be established due to, for example, a surface roughness of a coating covering the flexfoil comprising the light-emitting elements, wherein the aforementioned features together may form a lighting module. The air gap may be established between the lighting module or a coating of the lighting module and the at least one light guide. Further, the air gap may provide a peaked intensity distribution of light. For instance, applications that require high intensity levels in a certain direction (e.g., break light or rear turn light), the collimator may provide such a required peaked intensity distribution. The air gap between the lighting device and the light guide may be essential to enable the peaked intensity distribution. The peaked intensity distribution may arise as a result of a combination of the air gap with a collimator shape of the light guide, such as the parabola shape. The air gap itself may not collimate much if at all. If the air gap is not present, the TIR condition may not be met for the other surfaces of the light guide (e.g., rays may start in the medium itself and, hence, may have poorer TIR conditions than with the air gap being established). Thus, without the air gap, the collimating effect of the parabolic collimator light guide may be reduced.

The cavity may be a circular cavity. In some embodiments, the cavity may be a hole in the bottom part of the light guide (e.g., drilled in the longitudinal direction of the light guide). The light emitting elements or the lighting module may be inserted in the recess, such as represented by the circular cavity. Material of the light guide may fully enclose the light emitting elements or the flexfoil comprising the light emitting elements. The cavity may extend along the long axis of the collimator.

In the alternative, the recess may be at the bottom of the light guide, and the at least one light emitting element may not be fully surrounded by the light guide when it is embedded into the light guide. If the recess is not a cavity, to embed the light-emitting elements into, at least in part, the light guide, the encapsulating material may provide a fixation feature enabling to hold the light-emitting element in a certain place in relation to the light guide. It will be understood that the encapsulating material may, thus, also provide a fixation feature for enabling to connect the encapsulating material and the light guide.

The fixation feature may provide one or more mechanical reference features. For instance, the fixation feature may be in the form of wings or small and thin extensions on opposite sides of the light guide. Further, the at least one fixing element may also be used to orient the light guide in relation to the encapsulating material.

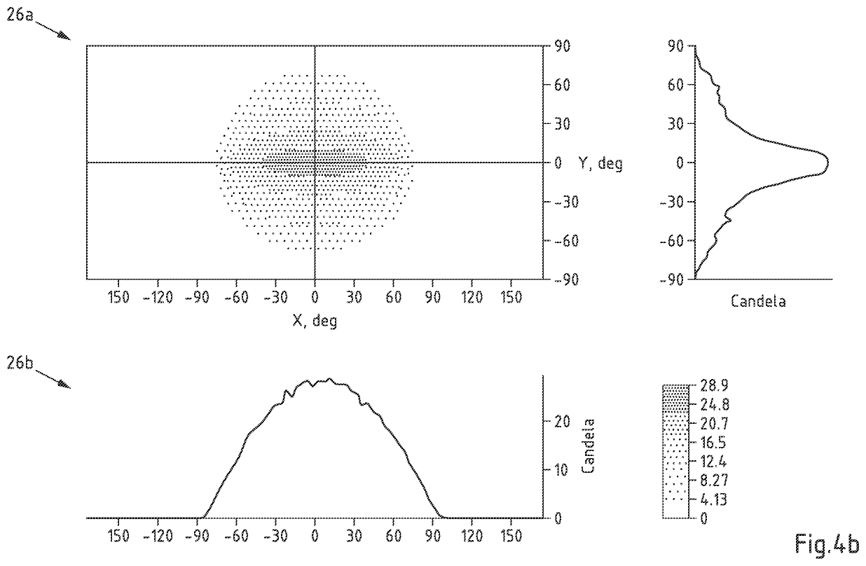

FIG. 4a is a schematic representation of the lighting device 2 of FIG. 3 in a cross-sectional view with visualized rays from optical simulation. In the example illustrated in FIG. 4a, rays are shown by the black lines that are guided by the light guide 4. It can be seen that the encapsulating material 10 may be reflective at least in the section in which the light guide 4 is arranged. Light emitted by the lighting module 22 that cannot be guided by the parabolic collimator through its flat surface 28 in the direction of the opening 14 of the encapsulating material 10 may be reflected back towards the light guide 4. In this way, optical efficiency of the lighting device according to the first aspect may be enhanced.

FIG. 4b is a diagram of the resulting intensity profile of the optical simulation performed according to the lighting device of FIG. 4a. The intensity profile 26a is strongly peaked due to the parabolic collimator comprising the lighting module in the recess 6 also being the focus point F of the collimator. Further, it can be seen in the candela profile 26b that stray light in particular at degrees of emission below 90° and above 90° is minimized. Thus, the lighting device 2 according to the first aspect enables very efficient emission since nearly all of the light emitted by the lighting module 22 is directed in its intended direction towards the opening of the encapsulating material 10.

The intensity profile 26a is shown in FIG. 4a with a high peak intensity in HV (on-axis). Due to the nature of the light module 22 having omni-directional emission of light, the light guide in the form of the parabolic collimator only collimates in one direction.

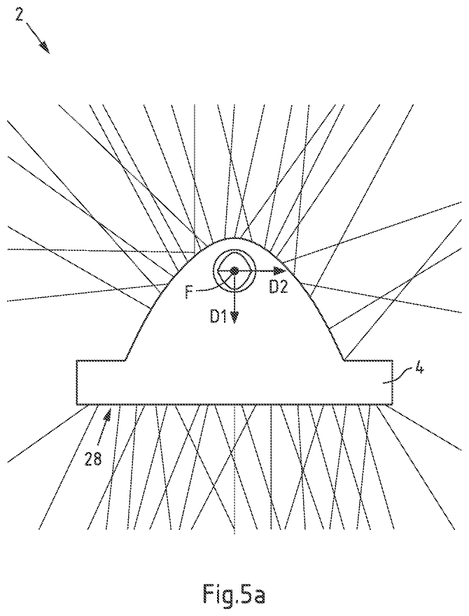

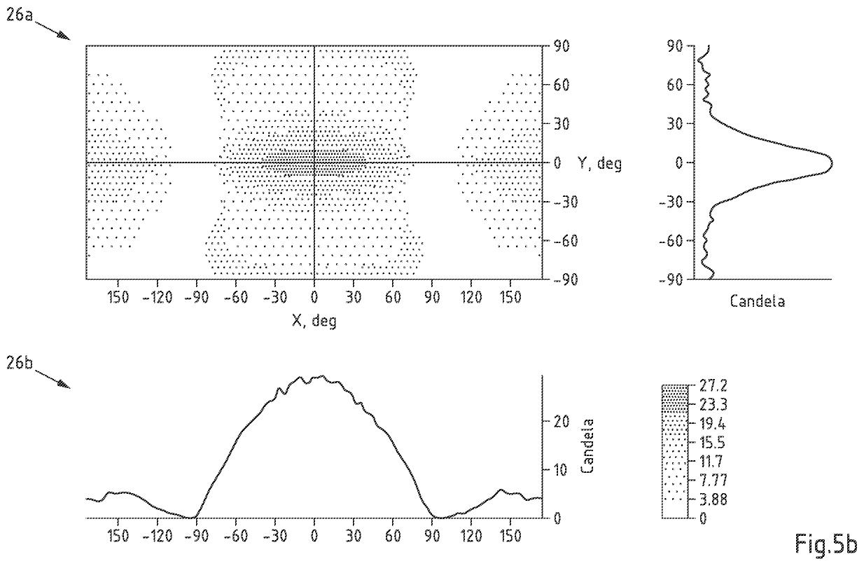

FIG. 5a is a schematic representation of another example lighting device 2 in a cross-sectional view with visualized rays from optical simulation. In the example illustrated in FIG. 5a, the light guide 4 is not encapsulated by an encapsulating material (see FIG. 3 and FIG. 4a). As in the example of FIG. 4a, the lighting module 22 may be integrated in the recess 6, which may be a cavity. Thus, the lighting module 22 may be fully surrounded by the light guide 4. Further, the light guide 4 may be in the form of a parabolic collimator having its focus point F in the center of the cavity.

In the example illustrated in FIG. 5a, rays are shown by the black lines that are guided by the light guide 4. It can be seen that some light emitted by the lighting module 22 may be guided by the parabolic collimator in a direction differing from its flat surface 28.

FIG. 5b is a diagram of the resulting intensity profile of the optical simulation performed according to the lighting device 2 of FIG. 5a. In the example illustrated in FIG. 5b, the encapsulating material 10 (e.g., a white mix box) is left out. The collimation may therefore completely rely on the TIR effect of the silicone/air interface (e.g., air gap) between the lighting device 22 and the light guide 4 on the parabola curve. In contrast to the embodiment shown in FIG. 4a, for example, the design of the embodiment shown in FIG. 5a may be simpler. However, using the light guide as the optics may make it such that the light guide is not well protected against, for example, dust/scratches. The light guide 4 of the embodiment shown in FIG. 5a may still comprise mechanical reference features (shown as ears in FIG. 5a). Such mechanical reference features may be still needed, for example, to mount the lighting device 2 with its embedded lighting module 22 to another element, such as a diffusor, lens or reflector, to name but a few non-limiting examples.

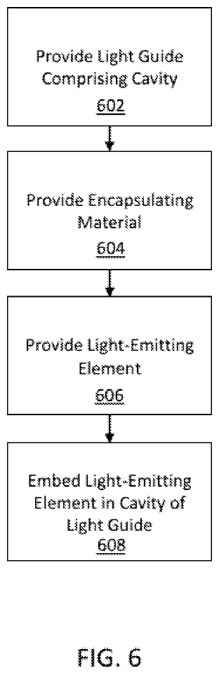

FIG. 6 is a flow diagram of an example method of manufacturing a lighting device. In the example illustrated in FIG. 6, the method includes providing a light guide comprising a cavity (602). In some embodiments, the cavity may have a middle, and the light guide may be a parabolic collimator having its focus point coincide with the middle of the cavity. An encapsulating material may be provided (604). In some embodiments, the encapsulating material may comprise at least one opening through which light may be emitted. At least one light-emitting element may be provided (606). The at least one light-emitting element may be embedded into the cavity in the light guide (608). In some embodiments, the light-emitting element may include a coating oriented towards the at least one opening of the encapsulating material. In some embodiments, the light-emitting element may be embedded in the cavity, for example, by inserting the light-emitting element mechanically into the cavity.

According to some embodiments, the method may also include encapsulating, at least in part, the at least one light guide with at least one encapsulating material. The encapsulating material may comprise at least one opening through which light may be emitted. For example, the at least one light guide with the light-emitting element may be encapsulated with the at least one encapsulating material. The light guide may be encapsulated with the encapsulating material so that the encapsulating material surrounds the light guide, at least in part. The encapsulating material may comprise an opening through which light is emitted when the light guide is arranged in relation to the encapsulating material.

This may be done by inserting the light guide comprising the light-emitting element into the encapsulating material, such as via the opening of the encapsulating material. One or more of the steps may be performed by a pick-and-place process. Additionally, or alternatively, at least some of the steps may be done manually or may be automated with a dedicated tool.

Further, multiple light-emitting elements may be arranged on (e.g., mounted to) a flexfoil strip. The flexfoil may be bendable. The light-emitting elements on the flexfoil strip may be coated, for example, with phosphor, as described above. This entire arrangement may also be bendable. The encapsulating material may be made out of or include silicone. Thus, the encapsulating material may also be bendable. The flexfoil with the multiple light-emitting elements may be encapsulated with the encapsulating material forming the finished lighting device.

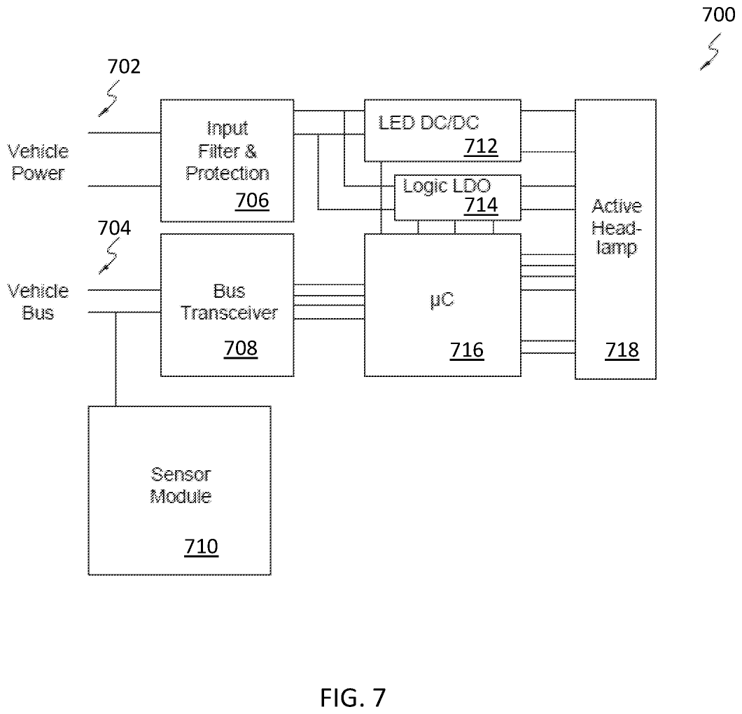

FIG. 7 is a diagram of an example vehicle headlamp system 700 that may incorporate one or more of the embodiments and examples described herein. The example vehicle headlamp system 700 illustrated in FIG. 7 includes power lines 702, a data bus 704, an input filter and protection module 706, a bus transceiver 708, a sensor module 710, an LED direct current to direct current (DC/DC) module 712, a logic low-dropout (LDO) module 714, a micro-controller 716 and an active head lamp 718.

The power lines 702 may have inputs that receive power from a vehicle, and the data bus 704 may have inputs/outputs over which data may be exchanged between the vehicle and the vehicle headlamp system 700. For example, the vehicle headlamp system 700 may receive instructions from other locations in the vehicle, such as instructions to turn on turn signaling or turn on headlamps, and may send feedback to other locations in the vehicle if desired. The sensor module 710 may be communicatively coupled to the data bus 704 and may provide additional data to the vehicle headlamp system 700 or other locations in the vehicle related to, for example, environmental conditions (e.g., time of day, rain, fog, or ambient light levels), vehicle state (e.g., parked, in-motion, speed of motion, or direction of motion), and presence/position of other objects (e.g., vehicles or pedestrians). A headlamp controller that is separate from any vehicle controller communicatively coupled to the vehicle data bus may also be included in the vehicle headlamp system 700. In FIG. 7, the headlamp controller may be a micro-controller, such as micro-controller (μc) 716. The micro-controller 716 may be communicatively coupled to the data bus 704.

The input filter and protection module 706 may be electrically coupled to the power lines 702 and may, for example, support various filters to reduce conducted emissions and provide power immunity. Additionally, the input filter and protection module 106 may provide electrostatic discharge (ESD) protection, load-dump protection, alternator field decay protection, and/or reverse polarity protection.

The LED DC/DC module 712 may be coupled between the input filter and protection module 706 and the active headlamp 718 to receive filtered power and provide a drive current to power LEDs in the lighting device in the active headlamp 718. The LED DC/DC module 712 may have an input voltage between 7 and 18 volts with a nominal voltage of approximately 13.2 volts and an output voltage that may be slightly higher (e.g., 0.3 volts) than a maximum voltage for the light-emitting elements in the lighting device (e.g., as determined by factor or local calibration and operating condition adjustments due to load, temperature or other factors).

The logic LDO module 714 may be coupled to the input filter and protection module 706 to receive the filtered power. The logic LDO module 714 may also be coupled to the micro-controller 716 and the active headlamp 718 to provide power to the micro-controller 716 and/or electronics in the active headlamp 718, such as CMOS logic.

The bus transceiver 708 may have, for example, a universal asynchronous receiver transmitter (UART) or serial peripheral interface (SPI) interface and may be coupled to the micro-controller 716. The micro-controller 716 may translate vehicle input based on, or including, data from the sensor module 710. The translated vehicle input may include a video signal that is transferrable to an image buffer in the active headlamp 718. In addition, the micro-controller 716 may load default image frames and test for open/short pixels during startup. In embodiments, an SPI interface may load an image buffer in CMOS. Image frames may be full frame, differential or partial frames. Other features of micro-controller 716 may include control interface monitoring of CMOS status, including die temperature, as well as logic LDO output. In embodiments, LED DC/DC output may be dynamically controlled to minimize headroom. In addition to providing image frame data, other headlamp functions, such as complementary use in conjunction with side marker or turn signal lights, and/or activation of daytime running lights, may also be controlled.

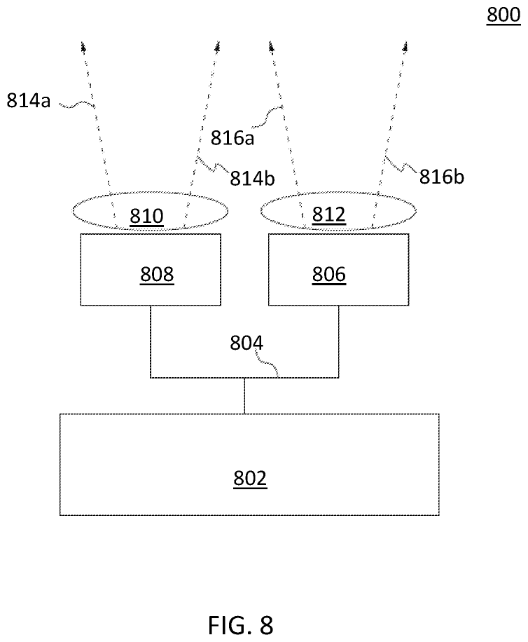

FIG. 8 is a diagram of another example vehicle headlamp system 800. The example vehicle headlamp system 800 illustrated in FIG. 8 includes an application platform 802, two lighting devices or systems 806 and 808, and secondary optics 810 and 812.

The lighting system or device 808 may emit light beams 814 (shown between arrows 814a and 814b in FIG. 8). The lighting system or device 806 may emit light beams 816 (shown between arrows 816a and 816b in FIG. 8). In the embodiment shown in FIG. 8, a secondary optic 810 is adjacent the lighting system or device 808, and the light emitted from the lighting system or device 808 passes through the secondary optic 810. Similarly, a secondary optic 812 is adjacent the lighting system or device 806, and the light emitted from the lighting system or device 806 passes through the secondary optic 812. In alternative embodiments, no secondary optics 810/812 are provided in the vehicle headlamp system.

Where included, the secondary optics 810/812 may be or include one or more light guides. The one or more light guides may be edge lit or may have an interior opening that defines an interior edge of the light guide. Lighting systems or devices 808 and 806 may be inserted in the interior openings of the one or more light guides such that they inject light into the interior edge (interior opening light guide) or exterior edge (edge lit light guide) of the one or more light guides, as described in detail above. In embodiments, the one or more light guides may shape the light emitted by the lighting systems or devices 808 and 806 in a desired manner, such as, for example, with a gradient, a chamfered distribution, a narrow distribution, a wide distribution, or an angular distribution.

The application platform 802 may provide power and/or data to the lighting systems or devices 806 and/or 808 via lines 804, which may include one or more or a portion of the power lines 702 and the data bus 704 of FIG. 7. One or more sensors (which may be the sensors in the vehicle headlamp system 700 or other additional sensors) may be internal or external to the housing of the application platform 802. Alternatively, or in addition, as shown in the example vehicle headlamp system 700 of FIG. 7, each lighting system or device 808 and 806 may include its own sensor module, connectivity and control module, power module, and/or LED array.

In embodiments, the vehicle headlamp system 800 may represent an automobile with steerable light beams where LEDs may be selectively activated to provide steerable light. For example, an array of LEDs or emitters may be used to define or project a shape or pattern or illuminate only selected sections of a roadway. In an example embodiment, infrared cameras or detector pixels within lighting systems or devices 806 and 808 may be sensors (e.g., similar to sensors in the sensor module 710 of FIG. 7) that identify portions of a scene (e.g., roadway or pedestrian crossing) that require illumination.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. A lighting device comprising:
at least one light guide comprising a cavity having a middle, wherein the at least one light guide is a parabolic collimator having its focus point coincide with the middle of the cavity;
an encapsulating material comprising at least one opening through which light is emitted; and
at least one light-emitting element embedded into the cavity of the light guide at the focus point of the light guide, the light-emitting element including a coating oriented towards the at least one opening of the encapsulating material.

2. The lighting device according to claim 1, wherein the parabolic collimator has a flat surface opposite to a parabolic cross-section of the parabolic collimator such that light that is emitted by the at least one light-emitting element is guided by the at least one light guide in a direction of the flat surface.

3. The lighting device according to claim 1, wherein the recess is elongated and extends along a longitudinal direction of the at least one light guide.

4. The lighting device according to claim 3, wherein the at least one light-emitting element that is embedded into the at least one light guide is surrounded by the at least one light guide and an air gap is established between the at least one light-emitting element and the at least one light guide.

5. The lighting device according to claim 1, wherein the collimator comprises a flexible material.

6. The lighting device according to claim 1, wherein the at least one light guide further comprises at least one fixing element configured to mechanically fix the at least one light guide to the encapsulating material.

7. The lighting device according to claim 1, wherein the at least one light-emitting element is on a flexfoil.

8. The lighting device according to claim 7, wherein the at least one light-emitting element comprises multiple light-emitting elements arranged along a longitudinal direction of the lighting device.

9. The lighting device according to claim 8, wherein the flexfoil is coated, at least in part, with a coating defining at least one wavelength in which light emitted by the at least one light-emitting element is converted.

10. The lighting device according to claim 9, wherein the flexfoil and the coating form a hemispherical shape, wherein the flexfoil together with the coating is embedded, at least in part, into the encapsulating material and, at least in part, into the at least one light guide.

11. The lighting device according to claim 1, wherein the encapsulating material surrounds the at least one light guide at three sides such that light emitted by the at least one light emitting element is blocked by the encapsulating material.

12. The lighting device according to claim 11, wherein the encapsulating material is configured to reflect light that emerges from the at least one light guide in a direction of the encapsulating material covering at least a part of the light guide.

13. A method of manufacturing a lighting device, the method comprising:
providing at least one light guide comprising a cavity having a middle, wherein the at least one light guide is a parabolic collimator having its focus point coincide with the middle of the cavity;
providing an encapsulating material comprising at least one opening through which light is emitted;
providing at least one light-emitting element; and
embedding the at least one light-emitting element into the cavity of the light guide at the focus point of the light guide, the light-emitting element including a coating oriented towards the at least one opening of the encapsulating material.

14. An automotive lighting system comprising:
at least one lighting device comprising:
at least one light guide comprising a cavity having a middle, wherein the at least one light guide is a parabolic collimator having its focus point coincide with the middle of the cavity,
an encapsulating material comprising at least one opening through which light is emitted, and
at least one light-emitting element embedded into the cavity of the light guide at the focus point of the light guide, the light-emitting element including a coating oriented towards the at least one opening of the encapsulating material;
at least one light-emitting element driver configured to provide a drive current to the at least one lighting device; and
a controller configured to receive at least one signal and provide at least one control signal the driver to turn the at least one light-emitting element ON and OFF according to the received at least one signal.

15. The automotive lighting system of claim 14, wherein the automotive lighting system is one of a head light, a back light, an interior light, or body light included in the body of a vehicle.
